(19) United States
(12) Patent Application Publication
(10) Pub. No.: US 2009/0013326 A1
(43) Pub. Date: Jan. 8, 2009

(54) A SYSTEM AND METHOD FOR RESOURCE MANAGEMENT AND CONTROL

(76) Inventors: Priit Vimberg, Tallinn (EE); Raivo Raestik, Tallinn (EE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/159,756

(22) PCT Filed: Dec. 29, 2006
(86) PCT No.: PCT/EE2006/000011

§ 371 Date: Jun. 30, 2008

(30) Foreign Application Priority Data
Dec. 30, 2005 (EE) P200500038

(51) Int. Cl. G06F 9/50

(52) U.S. Cl. 718/104

(57) ABSTRACT

The present invention relates to complete system and method for centralized management, control and integration of different resources, including normally non-compatible systems. Said resources can be of arbitrary type—people, assets, information systems as well as other resources, including moving objects. The system comprises information systems and hardware enabling the gathering, processing and transmission of initial information from different resources in real-time or possibly later and control of said resources based on predefined or elaborated rules. The invention also allows to store and to use the information related to the location of resources. The present invention being centrally controlled and managed open information system with possibility of resource billing, belongs to the field of universal information systems.

### FIELD OF THE INVENTION

The present invention relates to complete system and method for centralized management, control and integration of different resources, including normally non-compatible resources. Said resources can be of arbitrary type—people, assets, information systems as well as other resources, including moving objects. The system comprises information systems and hardware enabling the gathering, processing and transmission of initial information from different resources in real-time or possibly later and control of said resources based on predefined or elaborated rules. The invention also allows to store and to use the information related to the location of resources. The present invention being centrally controlled and managed open information system with possibility of resource billing, belongs to the field of resource management and control.

### PRIOR ART

Various applications of resource management and control systems are known which have been used for the management and control of specific resources. Common systems for management and control of specific resources are local and restricted to the particular geographical region. Widely spread are burglar alarm systems where information is collected by the sensors connected to the system and output devices are controlled according to predefined rules on the basis of collected and processed data, including the activation of alarm devices and radio transmitters. The burglar alarm systems are managed by locally connected keyboard or computer or via specific software using telephone network or Internet as a communication link. User identification or authentication is implemented by comparing of information in the burglar alarm systems, for instance a four-digit or longer number combination entered by the user via the keyboard is compared to the code stored in the burglar alarm systems. Conventional burglar alarm systems allow to classify the users into distinct groups and to differentiate individual users to a certain extent, for example as master user and common user. One of the disadvantages of burglar alarm systems is the need of specific software and sometimes also hardware for the management of equipment manufactured by various companies. The burglar alarm systems are also local and in case of deploying several burglar alarm systems the users and their rights should be separately determined. The types of input and output devices of burglar alarm systems are limited by power supply requirements as well as by data transfer methods, for instance supply voltage, analog data transmission, digital data transmission and so forth. In addition there exists information exchange between the burglar alarm systems and specific software designated for the communication with such systems.

Another common type of specific resource management and control systems is a building access control system where the system controller is connected with various input devices like keyboards, magnetic card readers, RFID readers, fingerprint readers, eye scanners etc. and output devices like motorized locks, control units of electric barriers and gates, electromagnetic striking plates and so forth. In the access control system the users and their rights are defined for the output control. The description of rules is mostly trivial and limited by potential capability of resources connected to the access control system, i.e. the performance of a control system is determined by the particular system controller and by sub-controllers and output devices connected to the system. Access control systems have also limitations dictated by particular geographical region and the specification of rights for an individual person in various access control systems is implemented separately for each system. In case the access control system can be connected via the communication system to the server then the gathering and storage of data is performed in the server. A general drawback of access control systems is non-compatibility of equipment used in different systems, in other words, the cooperation of access control systems produced by different manufacturers is rarely successful. The access control systems are also not designated for calculation, gathering, storage and processing of billing data.

A third common category consists of industrial controller systems which control technological processes in industry and manufacturing, as for example vehicle production lines, boiler house control systems, traffic light controllers and so forth.

Such controller systems mostly use various predefined rules with implementation timing and order. A general disadvantage of controller systems is that they are too closed and the modification of rights and rules is complicated. For instance the integration of controller systems for vehicle production line and urban traffic light system is generally not feasible. Similarly the information transfer is carried out using certain type of communication channels, as for example via telephone network.

A fourth typical category of resource management and control systems incorporates software-based electronic commercial information systems where sell and purchase operations are carried out using user authentication by electronic means. For example, in the electronic commercial information system a user can authenticate herself or himself via communication system and pay for the audiovisual information after which the information system provides the user permission to transfer the audiovisual product from the server connected with said electronic commercial information system to the computer of said user. Such solutions have a disadvantage that the systems are limited only to the control of digital resources.

A fifth typical category of resource management and control systems includes universal programmable logic systems allowing to control system's output devices using input devices connected with the system. The input and output devices are generally local and therefore related to the particular location. In addition the universal programmable logic systems presume the compatibility of input and output equipment with entire system. A system can be also supplemented by specific input and output modules which enable limited extension and distribution of the system for instance within one single building. In many cases the universal programmable logic systems need persons skilled in the art with very high qualification for installing and adjusting the system which possibly means more expensive maintenance costs during the later operation.

In the document WO 2005/069177 A1 (published on Jul. 28, 2005) an invention is disclosed describing a method for the control and monitoring of agricultural water systems by controllers allocated in different geographical locations. According to the method described in said invention the controllers are used for the gathering of information about the resources (i.e water); said information is then transferred to the server computer where it can be monitored by the users in their terminals which are connected to the said server. The method allows also the transmission of billing data for the usage of the resource. A drawback of the method is that it is oriented to the control and monitoring of one single resource (water) as well as insufficient user authentication, poor access rights delivering and limited rule set used for the resource control.

Document WO 00/31669 (published on Jun. 2, 2000) discloses an invention describing processing of input data and the control of connected access control devices by the controller. The web server software is installed in the controller for data presentation and the e-mail server software is installed for data transmission. The communication between the server and controllers is implemented through Internet. As a disadvantage one can mention very specific application area of the solution—access control system; the invention also has no means for the gathering and storage of billing data.

Document U.S. Pat. No. 5,793,125 (published on Aug. 11, 1998) discloses an invention where the sensors and other inputs connected to the controller are collecting the information which is used by applying in the controller the corresponding rules for the control of household electrical devices including on-off control. As a drawback of the invention the complexity of integration of geographically separated systems can be mentioned.

Document US 2005/0262091 A1 (published on Nov. 24, 2005) discloses an invention which relates to the resource control system and method implemented by specific Java J2EE platform. A main disadvantage of this invention is that it is oriented only for the management of software resources and the lack of possibility to create billing information.

Document WO 2005/052786 A3 (published on Jun. 9, 2005) discloses an invention in which the access of authenticated users to the resources is accomplished where the resources can be games, videos, music and software programs. A main disadvantage of said invention is the unavailability of means for billing information and also the absence of control options for other resources as well as the applying of limited users' type.

Document WO 2005/094075 A2 (published on Oct. 6, 2005) discloses an invention which is used for the control of domestic audio and video equipment. A drawback of this invention is the need of user registration as well as restricted use of the system only for the control of audio and video devices and the lack of possibility to add complementary rules.

From the Japanese document 2003162424 A (published on Jun. 6, 2003) an invention is disclosed used in household for the connection of various devices into common network and the integrated control of these devices in said network. A disadvantage of this invention is the absence of communication modules in many domestic appliances necessary for the connection to the system and therefore the number of devices connected to the common system is limited; also the system can be used only in a particular household.

Document U.S. Pat. No. 6,604,085 B1 (published on Aug. 5, 2003) discloses an invention which is used for the advertising and billing in vending machines. Exclusive use in vending machines can be mentioned as a drawback, also the necessity to authenticate users locally.

Document US 2002/0143949 A1 (published on Oct. 3, 2002) discloses an invention which is used for the management of network resources (usually network equipment). Disadvantages of this invention include limited use only for network resource management, necessity to describe the system resources in advance, and limited possibilities of changing the queued resource parameters.

Document US 2004/026078 A1 (published on Dec. 23, 2004) discloses an invention which is used for the running of program commands in a remote computer permitting also the use of e-mail by command transmission, the connection of remote computers into a cluster and the application of many client computers by the control of the same resource in a remote computer. As a drawback the connectivity of managed resources only to remote computer can be mentioned as well as the need of asking the data from the remote computer.

Document US 2003/0167329 A1 (published on Sep. 4, 2003) discloses an invention used for the localization of specific resources in a communication network and for the management of communication channel resources. Disadvantages of said invention comprise the orientation strictly for the search and management of specific network resources and also the restricted practicability to manage only the resources equipped with communication means.

Document U.S. Pat. No. 5,369,570 (published in Nov. 29, 1994) discloses an invention which is used for the planning of resource control in order to avoid resource utilization conflicts. The lack of information about the actual status and activities of the resources can be mentioned as a main disadvantage of the invention.

There is a well known information system UFIS (Universal Flight Information System; www.abb.at) used by ABB and also a software system MIS (Management Information System) used mainly by the analysis of airport management processes. A main disadvantage is that the system is designed as a software solution not monitoring the implementation of activities; it is also undetermined how the information is entered into the system.

Common disadvantages of above-mentioned inventions can be listed as follows:
orientation for the use in a particular application;
specific interface equipment used in the system;
limited amount of controlled resources;
complicated or impossible implementation of system integration and information exchange;
lack of unified central billing data gathering according to different use of various resources;
non-existence of an option to define the rights and rules by the system users freely and easily.

### SUMMARY OF THE INVENTION

The object of the invention is to provide a system and method of resource management and control which is universal in relation of other systems connected to it whereby the connected systems can be arbitrary systems allowing the use of one or many communication channels for information exchange with client devices and one or many server computers independently of the type of communication channel; and permitting the use of universal communication interface and/or the billing data gathering for the use and/or non-use of resources in the system.

The resource management and control system is a set of information systems, hardware devices and/or their control systems—an integrated platform designed for the aggregation of collected information which is further processed if necessary and transferred into determined channels and the billing information is also calculated. The resource management and control system is centrally controlled and managed open information system allowing for instance to perform the following activities:
resource identification;
creation, verification and determination of rights;
description of rules;
resource monitoring;
resource control;
recording and storage of information, including the data related to the location of resources;
billing data gathering for actions.

The resources are considered as various objects containing information or generating information or to which the access can be enabled or disabled. The resources can inter alia people, assets, information systems and other objects.

The information can be in arbitrary format, for example analog, digital, visual, generated by movement or by radiation. The resources are recognized during the identification process by one or many identification device(s) and/or method(s).

The rights are generally considered as enabling or disabling of one or many actions and/or activities related to the resources.

The rules are generally considered as behavior or operation instructions or a set of such instructions.

The monitoring is generally considered as intentional gathering of information about actions, activities, behavior and other aspects of resources.

The control is generally considered as purposeful delivering of commands and other information based on rights, rules or capacities and characteristics of devices and information systems, to the recipients including the resources, whereby the commands can be for instance actions, activities and behavior instructions.

The billing is generally considered as requesting the payment for the use and/or non-use and access to activities and actions related to the resources.

The system can be applied for instance for centralized identification of people and other resources (including other moving objects), for implementation and monitoring of their actions and activities according to the rights and rules effective in the system and for producing billing records in real-time or also afterwards as desired.

On the basis of identification results the actions and activities can be monitored and registered which provide a survey of activities (what, where, how, when, by whom etc. they have been accomplished).

On the basis of activities and/or non-activities the automated processes can be described which activate or stop the operation of resources (e.g. devices and information flows), transmit information or perform other actions according to the rights and specified rules.

In order to improve security the identification of resources can be accomplished via one or more identification means simultaneously, consecutively or during customized time period.

The billing is possible for any kind of activities, non-activities or actions related to the resources. Billing principles can belong to the system but not necessarily so—the billing module can receive information from the external applications specifying how and in what extent to collect payments for using the activities or actions. The billing module itself can perform the billing operations for activities or actions and/or transfer the billing data to other systems.

The rules determine general behavior of the system. There are normally two types of rules in the system—system-based rules and application-based rules.

System-based rules determine functional principles of the system—the algorithm. Usually the system-based rules form an inseparable part of the module whereby said rules can be replaced by freely defined system rules. The main program module is designed so that it contains as an invariable part the intercommunication logics and interfaces of all other system modules. The communication principles are transmitted from the rules module whereby the rules module can be flexibly modified. Such module architecture allows to change the program algorithm (if needed) without modifying the main program module.

Application-based rules (e.g. identification and pass rules in access control systems, behavior rules of devices in automatic control systems) determine functional algorithm of the application at the user's side. The application-based rules are described in the system similarly as the system-based rules. In this case the behavior rules of an arbitrary device can be described directly on the basis of functional features of corresponding device.

Different resources may have different rights for the specification of rules.

A resource management and control system contains generally a server computer with resource management software installed, communication modules, communication channels and user interfaces. The server may be connected to the database computer. The server is connected via communication modules with one or more communication channels, for example with mobile service channel, cable network or other communication link. The controlled and managed resource is connected to hardware- or software-based communication module according to the resource type; a communication module or the corresponding functionality may also be integrated into the resource being its inseparable part. Data exchange between the server's communication module and the communication module connected with the managed and controlled resource may be encrypted. The necessity of using the encrypted communication can be up to the user. The protocol used by the communication modules is normally public and made available for everybody. The resource management software installed on the server consists of program modules having different functionality, which exchange information with each other and also with communication modules. The resource management software generally contains the following program modules:
main program module and other program modules connected to it as follows:
identification module for the user recognition according to the identification means;
rights management module for the determination of rights assigned to the system or it's part or to the associated application or system specifying the permission of using the resources and/or enabling or disabling the access to the resources;
rules management module for the specification of resource behavior in entire system or in single part of the system or in the application or subsystem related to the system based on various events or tasks which may be defined according to the system capacities;
monitoring module for the gathering of information using embedded or external communication module or some other software module. The monitoring module is able to use various communication channels directly and is not dependent or related to one of the communication channels. The monitoring module allows to backup and prioritize various channels in order to ensure cost-effective and reliable use of the communication channels;
control module for the delivering of control commands and sending the information packets to various devices and/or systems connected with the resource management and control system via the embedded communication module, external communication module or some other software module. The control module may contain descriptions of functionality and performance of devices and other applications whereby the control module can receive the commands from the rules management module or from some other program module like for example from monitoring module;
billing module for the description of various billing cases and methods allowing to identify paid activities and to record billing data or to transfer the billing information to other information systems. The billing records are compiled according to said activities if necessary.

Various modules in the resource management and control system can be incorporated into one or more combined modules.

The resource management and control system comprises the functionality of gathering and distribution of information and uses it to manage and control any resources. In order to manage and control a resource the information from this resource is transmitted via communication module and other modules to the resource management software where the received information is treated, processed and billed as required according to the rights, rules and features of the resource management software; the information can subsequently be transmitted to any resource including the initial resource. The information related to the resource location can also be saved and used for the management and control of various resources.

### LIST OF DRAWINGS

FIG. 1 is a view of the logical structure of the system illustrating the resource management software with communication modules, resources and users.

FIG. 2 is a view of the layout of devices in the system describing also known solutions of prior art.

FIG. 3 is a view of an example illustrating the provided method.

### PREFERRED EMBODIMENTS OF THE INVENTION

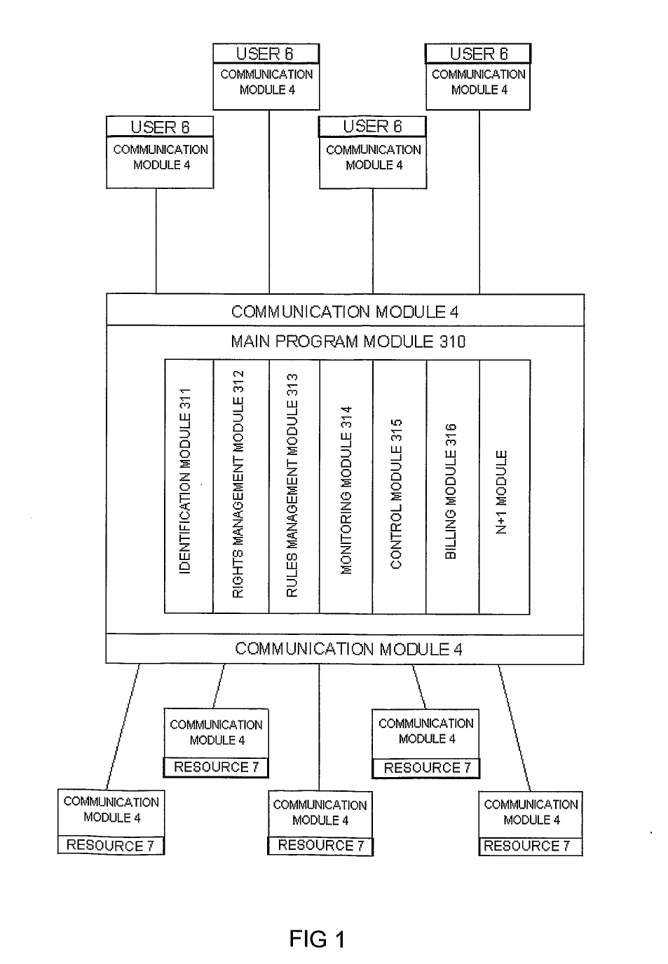

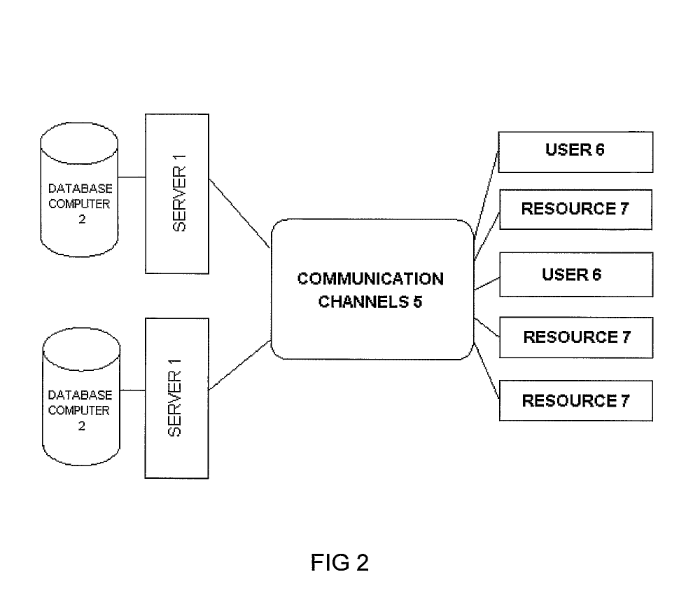

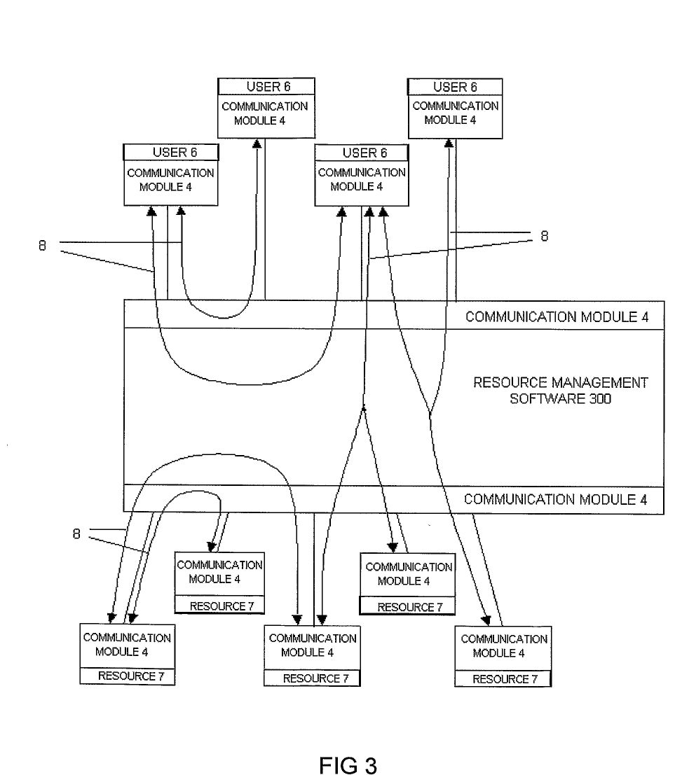

In following the preferred embodiments of the invention are described with reference to the components of invention according to FIGS. 1-3.

In one preferred embodiment a resource management and control system with respective system operating method comprises a server 1, a database computer 2, a resource management software 300, communication modules 4, a communication channel 5, a user interface 6, as well as an access control system as resources 7; the resource management software 300 contains respectively various program modules, as for instance main program module 310 with associated identification module 311, rights management module 312, rules management module 313, monitoring module 314, control module 315 and billing module 316. The resource management software 300, installed on the server 1, receives and transmits the information using communication modules 4 in server 1 which are connected to one end of the communication channel 5. At the other end of the communication channel 5 the resources 7 are connected via communication module 4 whereby the communication module 4 may be an inseparable part of the resource 7 transmitting the information 8 from the resource 7 to the resource management software 300 located on server 1. Following information about the properties of resource 7 is also entered into the resource management software 300 via the user interface 6:
1. Name: button. States: open, closed. Default state: open. Events: push, release.
2. Name: door lock. States: open, closed. Default state: closed. Events: open, close.

The rules for the resource 7 are also entered into the resource management software 300 on the basis of which the control of the resource 7 is performed:
1. If the button is pushed and released before 1 second then the door lock is opened for 4 seconds.
2. If the rule 1 is executed and the button is pushed once more in 2 seconds then the door lock is opened for 5 minutes.
3. If the button is pushed for 4 seconds then the door lock state will be inverted (closed <->open).

In another preferred embodiment of the invention a resource management and control system with respective system operating method comprises a server 1, a database computer 2, a resource management software 300, communication modules 4, a communication channel 5 and a user interface 6, as well as resources 7 including a client computer with calendar program and a mobile telephone; the resource management software 300 contains respectively various program modules, as for instance main program module 310 with associated identification module 311, rights management module 312, rules management module 313, monitoring module 314, control module 315 and billing module 316. The resource management software 300 installed on the server 1 receives and transmits the information using communication modules 4 in server 1 which are connected to one end of the communication channel 5. At the other end of the communication channel 5 the client computer with calendar program as a resource 7 is connected via communication module 4 whereby the communication module 4 may be an inseparable part of the resource 7 performing the information exchange 8 between the calendar program as a resource 7 and the resource management software 300 located on server 1. The rights and rules are determined by the user interface 6 in the resource management software 300 in such a way that in case of any relevant query via the mobile telephone as a resource 7 the resource management software 300 presents a right to read the information stored in the user's calendar program. In the billing module 316 of resource management software 300 a payment is also defined for using said resource 7 and in the rules management module 313 the activity is defined about the transmission of billing information and about the receiver of said information, for instance about the billing system of mobile service operator providing the communication channel 5.

In yet another preferred embodiment of the invention a resource management and control system with respective system operating method is provided comprising a server 1, a database computer 2, a resource management software 300, communication modules 4, a communication channel 5 and a user interface 6, as well as resources 7 including people with communication means and various communication programs; the resource management software 300 contains respectively various program modules, as for instance main program module 310 with associated identification module 311, rights management module 312, rules management module 313, monitoring module 314, control module 315 and billing module 316. The resource management software 300 installed on the server 1 receives and transmits the information using communication modules 4 in server 1 which are connected to one end of the communication channel 5. At the other end of the communication channel 5 the people with communication means as a resource 7 are connected via communication module 4 whereby the communication module 4 may be an inseparable part of the resource 7 performing the information exchange 8 between the people using communication means and various communication programs as a resource 7 and the resource management software 300 located on server 1. The resource management and control system allows to collect from different sources the status information about the people and other resources 7 including the presence information. The resource management and control system allows to collect information about the location, activities and other variables of the resources 7, for instance is the resource 7 currently at home, in office or in some other place or even driving a car, and is the resource 7 available by communication means like mobile phone, telephone or communication program (e.g. MSN Messenger, Skype etc.). According to collected information certain actions can be automated or decisions can be currently made. For example if the resource 7 is leaving the office the telephone can be automatically redirected to the mobile phone, a message can be sent to the communication program (e.g. MSN Messenger, Skype etc.) about the absence, a command can be sent to the computer to log out and lock the screen. If the resource 7 comes home the calls may be automatically directed from mobile phone to the home telephone or to the device equipped with communication software (e.g. Skype phone).

In yet another preferred embodiment of the invention a resource management and control system with respective system operating method is provided comprising a server 1, a database computer 2, a resource management software 300, communication modules 4, a communication channel 5 and a user interface 6 as well as resources 7 including audio-visual services (e.g. radio broadcast, videos etc.) provider, people and cars with playback means of said audio-visual services; the resource management software 300 contains respectively various program modules, as for instance main program module 310 with associated identification module 311, rights management module 312, rules management module 313, monitoring module 314, control module 315 and billing module 316. The resource management software 300 installed on the server 1 receives and transmits the information using communication modules 4 in server 1 which are connected to one end of one or more communication channels 5. At the other end of the communication channels 5 the audio-visual service provider or intermediate provider, people and cars with playback means of said audio-visual services as a resource 7 are connected via communication module 4 whereby the communication module 4 may be an inseparable part of the resource 7 performing the information exchange 8 between the people using communication means and various communication programs as a resource 7 and the resource management software 300 located on server 1. The resource management and control system allows the resource 7 using the user interface 6 to compile on the basis of collected presence information about the resource 7 the rules for the notification of resource 7 about the performance of music, videos, movies or other audi-visual services in various media channels according to the location of said resource 7. The resource management software 300 may, for instance, predefine a list of music pieces and if one of the songs is played by any radio station and the resource 7 is currently driving a car in the broadcasting area of this station then the information 8 is transmitted to the resource 7 about the performance of said music piece in particular time at certain media channel or a command is sent automatically to the car radio and to the resource 7 to change the channel. A resource 7 can also be notified about the performance of his or her favorite movie, TV serial or some other audio-visual service in TV-channels; if necessary it can be done only in case if the location of resource 7 matches the settings of rules specified in the resource management software 300. In industrial applications the corresponding decisions can be made after receiving of certain information flows or to process said information directly or on the basis of predetermined rules.

The resource 7 management and control system supports the reception of information represented in media channels by a supplier organization providing various audio-visual services. The information may be distributed by said organization itself or a company or automatic information system dealing with the monitoring of said organizations.

Above-mentioned preferred embodiments may function or exist autonomously or by interacting with each other.

The present invention is not limited to aforementioned preferred embodiments but comprises also other modifications which remain within the frame of the idea of the invention and the accompanying claims given below.

1. A resource management and control system comprising a server with installed resource management software, communication modules, communication channels, a user interface and resources whereby the server is connectable to a database computer and to one or more of the communication channels, wherein one of the communication modules is connected between the server and the communication channel and between the communication channel and the resource whereby any resource can be considered as a resource, and that the communication between the communication module located on the server and the communication module connected to the resource may be encrypted whereby the necessity of using the encrypted communication is up to the user.

2. System according to claim 1, wherein on the server, the resource management software is installed containing program modules with different functionality, and whereby a set of program modules is not limited.

3. System according to claim 2, wherein the program modules of the resource management software can be applied as one or many combined modules.

4. System according to claim 1, wherein a public and generally available protocol is used between the communication modules and different rights of rules determination can be assigned to the different resources and the communication module may be implemented as an inseparable part of the resource.

5. System according to claim 1, wherein the system can be used as a managed and controlled resource or a user interface.

6. A method for resource management and control comprising the functionalities of gathering and distribution of information, wherein one or more arbitrary resources are managed and controlled.

7. (canceled)

8. Method according to claim 6, wherein for the management and control of the resource, the information is transmitted from the said resource via communication modules or via other modules to resource management software where received information is treated, processed and billed as required according to rights, rules and capacities of the resource management software, and in case of need transmitted to any resource including an initial resource (7).

9. Method according to claim 8, wherein the system-based and application-based rules are used in the resource management and control system.

10. Method according to claim 6, wherein users of the resource management and control system are identified if necessary by the said system using a user interface.

11. Method according to claim 6, wherein the information related to a location of resources is stored for the resources.

12. Method according to claim 6, further comprising employing a system that includes: a server with installed resource management software, communication modules, communication channels, a user interface and resources, whereby the server is connectable to a database computer and to one or more of the communication channels and wherein one of the communication modules is connected between the server and the communication channel and between the communication channel and the resource whereby any resource can be considered as a resource, and that the communication between the communication module located on the server and the communication module connected to the resource may be selectively encrypted.
